(19) United States
(12) Patent Application Publication
(10) Pub. No.: US 2025/0233728 A1
(43) Pub. Date: Jul. 17, 2025

(54) AUTHENTICATED ENCRYPTION WITH ASSOCIATED DATA (AEAD) MODES FOR NON-ACCESS STRATUM (NAS) AND ACCESS STRATUM (AS) SECURITY

(71) Applicant: Lenovo (United States) Inc., Morrisville, NC (US)

(72) Inventors: Sheeba Backia Mary BASKARAN, Friedrichsdorf (DE); Andreas Kunz, Ladenburg (DE)

(21) Appl. No.: 19/097,333

(22) Filed: Apr. 1, 2025

(51) Int. Cl. H04L 9/08; H04L 9/06

(52) U.S. Cl. CPC H04L 9/0816; H04L 9/0631

(57) ABSTRACT

Various aspects of the present disclosure relate to using authenticated encryption with associated data (AEAD) algorithms for both non-access stratum (NAS) and access stratum (AS) security mode command procedures. For example, the technology enhances or updates the command procedures (e.g., AS, NS, radio resource control (RRC) reconfiguration) to enable communications between a network entity and a user equipment (UE) that identify selected AEAD algorithms and/or AEAD modes during AS and NAS security establishment.

### TECHNICAL FIELD

The present disclosure relates to wireless communications, and more specifically to utilizing authentication encryption with associated data (AEAD) modes for non-access stratum (NAS) and access stratum (AS) security.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that implement AEAD algorithms for NAS and AS security, including control plane and/or user plane security.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network entity, a security mode command message that contains security mode information, including: a security context parameter that indicates a security context for communications between the UE and the network entity, one or more AEAD algorithms associated with the security context, and one or more AEAD modes associated with the one or more AEAD algorithms, generate an AEAD security key based on the one or more AEAD algorithms and the one or more AEAD modes, and transmit, to the network entity, a security mode complete message that is ciphered and integrity protected with the AEAD security key.

A processor for wireless communication is described. The processor may be configured to, capable of, or operable to perform one or more operations as described herein. For example, the processor may comprise at least one memory and at least one controller coupled with the at least one memory and configured to cause the processor to receive, from a network entity, a security mode command message that contains security mode information, including: a security context parameter that indicates a security context for communications between the UE and the network entity, one or more AEAD algorithms associated with the security context, and one or more AEAD modes associated with the one or more AEAD algorithms, generate an AEAD security key based on the one or more AEAD algorithms and the one or more AEAD modes, and transmit, to the network entity, a security mode complete message that is ciphered and integrity protected with the AEAD security key.

A method performed or performable by the UE device is described. The method may comprise receiving, from a network entity, a security mode command message that contains security mode information, including: a security context parameter that indicates a security context for communications between the UE and the network entity, one or more AEAD algorithms associated with the security context, and one or more AEAD modes associated with the one or more AEAD algorithms, generating an AEAD security key based on the one or more AEAD algorithms and the one or more AEAD modes, and transmitting, to the network entity, a security mode complete message that is ciphered and integrity protected with the AEAD security key.

In some implementations of the UE, processor, and method described herein, the security context parameter indicates a NAS security context for the communications between the UE and the network entity.

In some implementations of the UE, processor, and method described herein, the security context parameter indicates an AS security context for the communications between the UE and the network entity.

In some implementations of the UE, processor, and method described herein, the AS security context includes a radio resource control (RRC) security context.

In some implementations of the UE, processor, and method described herein, the AS security context includes a user plane (UP) security context.

In some implementations of the UE, processor, and method described herein, wherein the security mode command message contains a prioritized list of AEAD algorithms selected by the network entity, the UE, processor, and method may further be configured to, capable of, performed, performable, or operable to generate the AEAD security key using an AEAD algorithm that is supported by the UE and that has a high priority in the prioritized list.

In some implementations of the UE, processor, and method described herein, the one or more AEAD algorithms include a SNOW-3G based algorithm, an advanced encryption standard (AES) based algorithm, or a ZUC based algorithm.

In some implementations of the UE, processor, and method described herein, the one or more AEAD modes include: an encrypt-then-MAC (EtM) mode, a MAC-then-encrypt (MtE) mode, an encryption only mode, or an integrity only mode.

A network entity for wireless communication is described. The network entity may be configured to, capable of, or operable to perform one or more operations as described herein. For example, the network entity may comprise at least one memory and at least one processor coupled with the at least one memory and configured to cause the network entity to receive, from a UE, a message that contains security capabilities supported by the UE, including one or more AEAD algorithms associated with a security context for communications between the UE and the network entity and one or more AEAD modes associated with the one or more AEAD algorithms, generate an AEAD security key using an AEAD algorithm and an AEAD mode that are supported by the UE, and transmit, to the UE, a security mode command message that contains security mode information indicating the AEAD algorithm and the AEAD mode used to generate the AEAD key.

A method performed or performable by the network entity is described. The method may comprise receiving, from a UE, a message that contains security capabilities supported by the UE, including one or more AEAD algorithms associated with a security context for communications between the UE and the network entity and one or more AEAD modes associated with the one or more AEAD algorithms, generating an AEAD security key using an AEAD algorithm and an AEAD mode that are supported by the UE, and transmitting, to the UE, a security mode command message that contains security mode information indicating the AEAD algorithm and the AEAD mode used to generate the AEAD key.

In some implementations of the network entity and method described herein, the network entity and method may further be configured to, capable of, performed, performable, or operable to receive, from the UE, a security mode complete message that indicates an AEAD algorithm and an AEAD mode used by the UE, de-cipher and check integrity protection applied to the security mode complete message using the generated AEAD key and the indicated AEAD algorithm and AEAD mode, and activate downlink ciphering with the UE using the security context.

In some implementations of the network entity and method described herein, the security context is a NAS security context for the communications between the UE and the network entity.

In some implementations of the network entity and method described herein, the security context is an AS security context for the communications between the UE and the network entity.

In some implementations of the network entity and method described herein, the AS security context includes an RRC security context.

In some implementations of the network entity and method described herein, the AS security context includes a UP security context.

In some implementations of the network entity and method described herein, the network entity is an AMF, a NAS termination point function, or a control plane termination point.

In some implementations of the network entity and method described herein, the network entity is a radio access network (RAN) node.

In some implementations of the network entity and method described herein, the one or more AEAD algorithms include a SNOW-3G based algorithm, an AES based algorithm, or a ZUC based algorithm.

In some implementations of the network entity and method described herein, the one or more AEAD modes include an EtM mode, an MtE mode, an encryption only mode, or an integrity only mode.

A RAN node for wireless communication is described. RAN node may be configured to, capable of, or operable to perform one or more operations as described herein. For example, the RAN node may comprise at least one memory and at least one processor coupled with the at least one memory and configured to cause the RAN node to transmit, to a UE, an RRC connection reconfiguration message that contains an indication of an AEAD mode for activation of UP integrity protection or ciphering for data radio bearer (DRB) additions during an RRC reconfiguration procedure, initiate, for each DRB, uplink UP integrity verification and downlink UP integrity protection using the AEAD mode, and initiate, for each DRB, uplink UP deciphering and downlink UP ciphering using the AEAD mode.

A method performed or performable by the RAN node is described. The method may comprise transmitting, to a UE, an RRC connection reconfiguration message that contains an indication of an AEAD mode for activation of UP integrity protection or ciphering for data radio bearer (DRB) additions during an RRC reconfiguration procedure, initiating, for each DRB, uplink UP integrity verification and downlink UP integrity protection using the AEAD mode, and initiating, for each DRB, uplink UP deciphering and downlink UP ciphering using the AEAD mode.

### BRIEF DESCRIPTION OF THE DRAWINGS

FIG. 1 illustrates an example of a wireless communications system in accordance with aspects of the present disclosure.

FIG. 2 illustrates an example of messaging between an NE and a UE in accordance with aspects of the present disclosure.

FIG. 3 illustrates an example messaging flow during a NAS SMC procedure in accordance with aspects of the present disclosure.

FIG. 4 illustrates an example messaging flow during an AS SMC procedure in accordance with aspects of the present disclosure.

FIG. 5 illustrates an example messaging flow during an RRC Reconfiguration procedure in accordance with aspects of the present disclosure.

FIG. 6 illustrates an example of a user equipment (UE) in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

FIG. 11 illustrates a flowchart of a method performed by an NE in accordance with aspects of the present disclosure.

### DETAILED DESCRIPTION

NAS security establishes encryption and integrity protection for NAS signaling between a UE and network functions of the wireless communication system, such as an Access and Mobility Function (AMF). Similarly, AS security establishes encryption and integrity protection between the UE and a radio access network (RAN) of the wireless communication system.

The present disclosure relates to methods, apparatuses, and systems that implement AEAD algorithms for NAS and AS security, including control plane and/or user plane security. Currently, NAS and AS security mode command (SMC) procedures do not support the use or negotiation of AEAD algorithms, due to various limitations. For example, some NAS and AS security procedures use different keys for ciphering and integrity protections. Also, AS security utilizes one order of encryption and integrity protection (e.g., MAC-then-Encrypt, or MtE) whereas NAS security utilizes a different order (e.g., Encrypt-then-MAC, or EtM). In contrast, AEAD algorithms apply a single key for both ciphering and integrity protection and apply a single-pass operation (e.g., using one order or mode) when performing encryption and integrity protection.

The technology described herein enables the use of AEAD algorithms for both NAS and AS security mode command procedures. For example, the technology enhances or updates the command procedures (e.g., AS, NS, radio resource control (RRC) reconfiguration) to enable communications between an NE and a UE that identify selected AEAD algorithms and/or AEAD modes during AS and NAS security establishment. Thus, the NE may utilize the benefits of AEAD when establishing AS and NAS security for AS and NAS communications within the wireless communications system, among other benefits.

Aspects of the present disclosure are described in the context of a wireless communications system.

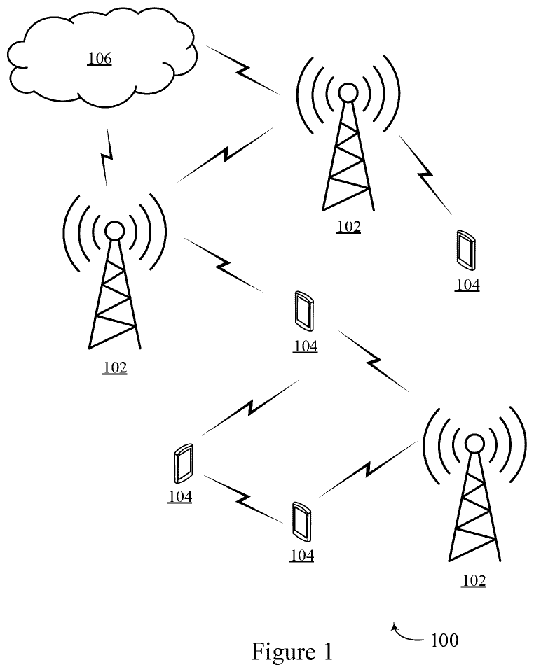

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more aspects depicted herein enable the use of AEAD algorithms for both NAS and AS security, such as during SMC procedures. For example, the UE 104 may be configured and/or capable to support or utilize AEAD algorithms or other combined authenticated encryption algorithms (e.g., Snow-3G, AES, and ZUC) and related different AEAD modes, such as EtM, MtE, encryption only, integrity only, and so on. The UE 104 may indicate to the NE 102 (e.g., in a NAS message/N1 transport) its security capabilities for AEAD mode support, as well as an authenticated encryption algorithm code for any supported AEAD algorithm (e.g., a code representative of Snow-3G, AES, ZUC, and so on).

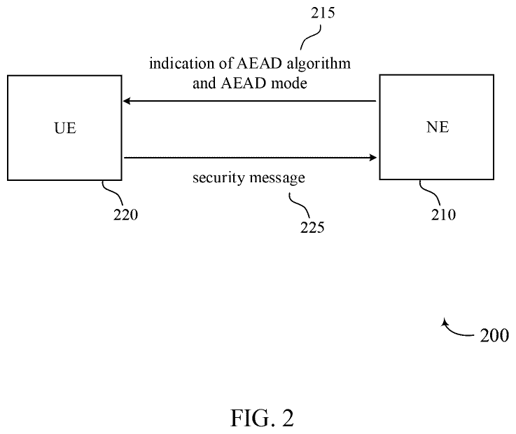

FIG. 2 illustrates an example of messaging 200 between an NE 210 and a UE 220 in accordance with aspects of the present disclosure. The NE 210 (e.g., an AMF) may transmit an indication 215 of a selected AEAD algorithm and AEAD mode to the UE 220. The UE 220, applying the indicated AEAD algorithm and AEAD mode, may transmit a security message 225 back to the NE 210 during a SMC procedure (e.g., an AS or NAS SMC).

The UE 220 and/or NE 210 may generate a security key (e.g., an AS or NAS security key) using the selected AEAD algorithm in a variety of ways. For example, in some cases, the UE 220 and/or NE 210 may perform a combined authenticated encryption algorithm ID/AEAD algorithm ID specific AEAD NAS/AS security key derivation (K_{NASaead} Or K_{ASaead}). For example, the K_{NASaead} key (e.g., 256 bits or 128 bits (truncated from 256 bits)) may be derived by the NE 210 from a K_{AMF}, which is used for protection of NAS signaling with a selected authenticated encryption/AEAD related algorithm type distinguisher and related algorithm ID/AEAD algorithm ID. The NE 210 may also use the AEAD mode as an additional input (e.g., a code point or indication related to a selected AEAD mode.

In some cases, the UE 220 and/or NE 210 may utilize a concatenation for AEAS security key derivation from existing security keys. For example, the UE 220 and/or NE 210 may concatenate 128 bits of a K_{NASint} key and 128 bits of a K_{NASenc} key (K_{NASint}∥K_{NASenc}) and use the concatenated key as the security key for AEAD based NAS security. The 128 bits of each of the K_{NASint} key and the K_{NASenc} key may be a truncated existing K_{NASint} key and K_{NASenc} key and/or can be 128 bits of a least significant bit (LSB) or a most significant bit (MSB) from its original 256 bits key length (e.g,, the K_{NASint} and K_{NASenc} before the truncation, where the 256-bit K_{NASint} and the 256-bit K_{NASenc} are derived from the K_{AMF}).

In some cases, the UE 220 and/or NE 210 may reuse existing NAS integrity or encryption keys as the AEAD security key, based on the type of AEAD mode being used or based on the authenticated encryption core algorithm used for the signaling security (e.g., between the UE 220 and the NE 210). For example, based on the type of combined authenticated encryption algorithm being used, the UE 220/NE 210 may utilize the algorithm IDs related to the algorithms used for AEAD (e.g., existing algorithm type distinguisher and existing algorithm identifier related to Snow3G/AES/ZUC specific to the core algorithm being used in AEAD) as relevant and perform related K_{NASint} and K_{NASenc} generation. Then, for any AEAD mode, the UE 220/NE 210 may either use 256 bits of the K_{NASint} key as the AEAD NAS key (and ignore/drop the K_{NASenc} key) or 256 bits of the K_{NASenc} key as the AEAD NAS key (and ignore/drop the K_{NASint} key) as per a configuration specified in the UE 220 and the NE 210 and/or based on operator policy.

In some examples, the NE 210 may send the indication 215 to another NE 210 (from an AMF to a gNB/ng-eNB/6G RAN node). The RAN node, based on the indication 215, may apply authenticated encryption along with a suitable AEAD mode for NAS or AS security along with the security capabilities of the UE 220 (e.g., the selected AEAD mode and selected AEAD algorithm). Upon receiving the indication 215, the UE 220 may select and/or apply the AEAD mode and AEAD algorithm and generate an AEAD security key for signaling security (e.g., for AS security (RRC and UP security), NAS security, and so on).

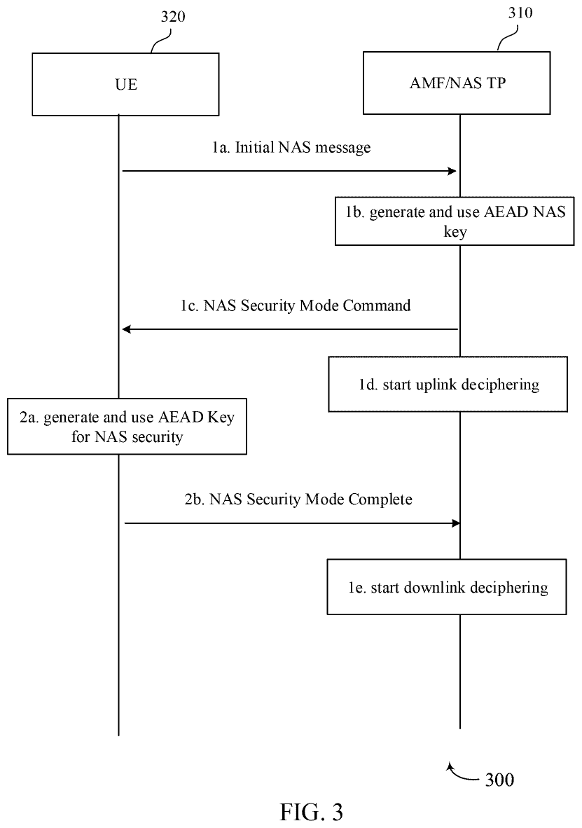

In some examples, a network function (e.g., an AMF) may enable selection and use of AEAD modes during NAS SMC for NAS security (e.g., security for NAS signaling) and/or protection (e.g., ciphering and/or integrity protection). The AMF may generate AEAD NAS security keys (K_{NASaead}) based on AEAD capabilities of the UE (e.g., the UE 220). FIG. 3 illustrates an example messaging flow 300 during a NAS SMC procedure in accordance with aspects of the present disclosure.

The messaging flow 300 may implement various aspects of the present disclosure described herein. For example, the messaging flow 300 may include an AMF 310 (or NAS termination point (TP) function) and a UE 320, which may be examples of AMFs and UEs as described herein. In the following description of the messaging flow 300, the operations between the AMF 310 and the UE 320 may be performed in different orders or at different times. Some operations may also be omitted, or other operations may be added. Although the AMF 310 and the UE 320 are shown performing the operations of the messaging flow 300, some aspects of some operations may also be performed by other entities of the messaging flow 300 or by entities that are not shown in the messaging flow 300, or any combination thereof.

The messaging flow 300 establishes a NAS security context between the UE 320 and the AMF 310 and includes messages between the AMF 310 and the UE 320. For example, the AMF 310 sends a NAS Security Mode Command message to the UE 320 and the UE 320 replies with the NAS Security Mode Complete message. In some cases, the UE 320, operating in an RRC_Connected mode and the UE 320 may have agreement for algorithms (e.g., 128 bits or 256 bits) used for NAS ciphering and/or NAS integrity protection, which support AEAD/authenticated encryption-based NAS signaling protection.

In some cases, a NAS SMC procedure represented by the messaging flow 300 protects a Registration Request against a man-in-the-middle attack, where an attacker modifies information elements (IEs), In some examples, the IEs may include one or more UE security capabilities provided by the UE 320 in the Registration Request. For example, upon a successful completion of the NAS SMC procedure, the UE 320 is attached to the network (e.g., the AMF 310) with knowledge that a bidding down attack has not occurred. If there was an attempted bidding down attack, the verification of the NAS SMC procedure fails and the UE 320 replies with a reject message indicating the UE 320 will not attach to the network.

At step 1a, the UE 320 transmits an initial NAS message to the AMF 310. For example, when the UE 320 supports combined authenticated encryption (e.g., AEAD), the UE 320 indicates the corresponding UE security capabilities to the network in a NAS message/N1 transport/initial NAS message (e.g., a Registration Request/Mobility Registration update/Periodic Registration update/any initial NAS message/PDU session establishment/modification request message, and so on) along with a UE identifier, such as a subscription concealed identifier (SUCI), a 5G global unique temporary identifier (5G-GUTI), and so on.

In some cases, the UE security capabilities may include authenticated encryption algorithms (e.g., AEAD), authenticated encryption algorithms based on SNOW 3G/AES/ZUC, and so on, which can either be 128 bits or 256 bits or 512 bits or so on. The AEAD modes include enc+int/(EtM), int+enc (MtE), enc-only, and/or int-only, where the modes indicate or relate to support of integrity or ciphering/encryption, or both, and the order of application during NAS security. In some cases, the UE 320 may transmit its security capabilities (e.g., supported AEAD algorithms and/or AEAD modes) in any NAS message.

After primary authentication, the AMF 310, at step 1b, generates and uses an AEAD NAS key. For example, the AMF 310 may determine to select and apply the combined authenticated encryption algorithm protection upon receiving the security capabilities from the UE 320 and/or upon an operator policy including AEAD algorithms in a prioritized list. The AMF 310 generates the AEAD NAS key and activates NAS integrity protection (before sending a NAS Security Mode Command message) by using the selected AEAD algorithm (e.g., a highest shared priority algorithm) in an AEAD mode (e.g., int-only) and uses the AEAD NAS key for the NAS signaling protection.

The following are example ciphering algorithm identifier values (e.g., for 5G NAS and NR):

| | | |
|---|---|---|
| “0000₂” | NEA0 | Null ciphering algorithm; |
| “0001₂” | 128-NEA1 | 128-bit SNOW 3G based algorithm; |
| “0010₂” | 128-NEA2 | 128-bit AES based algorithm; and |
| “0011₂” | 128-NEA3 | 128-bit ZUC based algorithm. |
| “0100₂” | 256-NEA4 | 256-bit SNOW 3G based algorithm; |
| “0101₂” | 256-NEA5 | 256-bit AES based algorithm; and |
| “0110₂” | 256-NEA6 | 256-bit ZUC based algorithm. |

The following are example integrity algorithm identifier values (e.g., for 5G NAS and NR):

| | | |
|---|---|---|
| “0000₂” | NEA0 | Null Integrity protection algorithm; |
| “0001₂” | 128-NIA1 | 128-bit SNOW 3G based algorithm; |
| “0010₂” | 128-NIA2 | 128-bit AES based algorithm; and |
| “0011₂” | 128-NIA3 | 128-bit ZUC based algorithm. |
| “0100₂” | 256-NIA4 | 256-bit SNOW 3G based algorithm; |
| “0101₂” | 256-NIA5 | 256-bit AES based algorithm; and |
| “0110₂” | 256-NIA6 | 256-bit ZUC based algorithm. |

The following are combined Authenticated Encryption Algorithms at the UE 320, RAN (for AS (RRC and UP)) and/or core network functions, such as the AMF 310 (for NAS):

| | | |
|---|---|---|
| “0000₂” or “0111₂” | 256-NCA7 | 256-bit SNOW 3G based |
| | | algorithm - AEAD; |
| “0001₂” or “1000₂” | 256-NCA8 | 256-bit AES based |
| | | algorithm - AEAD; and |
| “0010₂” or “1001₂” | 256-NCA9 | 256-bit ZUC based |
| | | algorithm - AEAD, |

Where NCA refers to a next generation combined authenticated encryption algorithm.

At step 1c, the AMF 310 sends a NAS Security Mode Command message to the UE 320. A NAS Security Mode Command may include: the replayed UE security capabilities with support of combined authenticated encryption algorithms (e.g., code related to Snow-3G, AES and ZUC based AEAD) and the related different supported AEAD modes supported (e.g., enc+int/(EtM), int+enc (MtE), enc-only, int-only), per AEAD algorithm, the selected NAS algorithms, an enable/selected AEAD mode, and an ngKSI for identifying the KAMF.

The NAS Security Mode Command message may include: a K_AMF_change_flag (e.g., within an additional 5G security parameters IE specified in TS 24.501) to indicate a newly calculated K_{AMF}, a flag requesting complete initial NAS message (e.g., see subclause 6.4.6), and/or an Anti-Bidding down Between Architectures (ABBA) parameter indicating “combined authenticated encryption activated/Use AEAD NAS key indication (if needed).” For a horizontal derivation of the K_{AMF} during a mobility registration update or during multiple registration in a same public land mobile network (PLMN), the message includes the K_AMF_change_flag (e.g., see clause 6.9.3 TS 33.501).

In some cases, when the AMF 310 determines to apply combined authenticated encryption for NAS protection, the NAS Security Mode Command message is integrity protected (but not ciphered) with an AEAD NAS (K_{NASaead}) based on the K_{AMF} indicated by the ngKSI in the NAS Security Mode Command message. Further, the ABBA may be sent to the UE 320 via an individual IE.

In some cases, when the AMF 310 or CN supports interworking using an N26 interface between a Mobility Management Entity (MME) and the AMF 310, the AMF 310 may include selected evolved packet system (EPS) NAS algorithms (e.g., defined in Annex B of TS 33.401) to be used after mobility to the EPS in the NAS Security Mode Command message. The UE 320 may store the algorithms for use after mobility to the EPS using the N26 interface between the MME and the AMF 310. The AMF 310 may also store the selected EPS NAS algorithms in the UE security context.

In some cases, such as when there is a change in the AMF during an N2-handover or idle mode mobility, the selected EPS NAS algorithms are included in the 5G UE security context and provided to a target AMF as part of the 5G UE security context.

At step 1d, the AMF 310 stars uplink deciphering. For example, when the AMF 310 determines to apply combined authenticated encryption algorithm for NAS protection, the AMF 310 activates NAS uplink deciphering using the AEAD NAS key in the AEAD mode after sending the NAS Security Mode Command message to the UE 320 (at step 1c).

At step 2a, the UE 320 generates and uses the AEAD key for NAS security. For

example, the UE 320 may determine to derive the AEAD NAS key based on the received selected NAS algorithms, indicating combined authenticated encryption and/or based on the received “combined authenticated encryption activated/Use AEAD NAS key indication” from the AMF 310.

The UE 320 may verify the NAS Security Mode Command message. For example, the UE 320 may check or confirm the UE security capabilities with combined authenticated encryption support information and the related AEAD mode support information sent by the AMF 310 match the capabilities stored in the UE 320 to ensure that the capabilities were not modified by an attacker. The UE 320 may also verify the integrity protection using the indicated NAS protection algorithm (e.g., combined authenticated encryption algorithm) and the AEAD NAS security key based on the K_{AMF} indicated by the ngKSI. When the NAS Security Mode Command message includes a K_AMF_change_flag, the UE 320 may derive a new K_{AMF} (e.g., as described in Annex A.13 TS33.501) and set a NAS COUNTs to zero.

The UE 320, when verification of the integrity of the NAS Security Mode Command message is successful, starts NAS integrity protection and ciphering/deciphering using the indicated combined authenticated encryption algorithm in the AEAD mode with the security context (e.g., the AEAD NAS security key) indicated by the ngKSI.

At step 2b, the UE 320 transmits a NAS Security Mode Complete message to the AMF 310. For example, the transmits a ciphered and integrity protected (e.g., with the AEAD NAS security key) NAS Security Mode Complete to the AMF 310. The NAS Security Mode Complete message may include a permanent equipment identifier (PEI) when requested by the AMF 310 in the NAS Security Mode Command message (at step 1c). The AMF 310 may set the NAS COUNTs to zero when horizontal derivation of K_{AMF} is performed. In some cases, the UE 320 includes the complete initial NAS message (see step 1a).

In some cases, when the verification of the NAS Security Mode Command message is not successful in the UE 320, the UE 320 may reply with a NAS Security Mode Reject message (see TS 24.501). The NAS Security Mode Reject message and all subsequent NAS messages may be protected with a previous (if any) 5G NAS security context (e.g., a 5G NAS security context used prior to the failed NAS Security Mode Command message) or be unprotected (e.g., when no 5G NAS security context existed prior to the NAS Security Mode Command message).

In some cases, the AMF 310 de-ciphers and checks the integrity protection on the NAS Security Mode Complete message using the key and algorithm indicated in the NAS Security Mode Command message. At step 1e, the AMF 310 starts downlink deciphering. For example, the AMF 310 activates NAS downlink ciphering (e.g., with the AEAD NAS security key) after receiving the NAS Security Mode Complete message.

In some cases, such as when an uplink NAS COUNT wraps around by sending the NAS Security Mode Reject message, the UE 320 releases the NAS connection instead of sending an NAS Security Mode Reject message. Also, when the AMF 310 successfully validates the NAS SMC Complete message, the AMF 310 successfully confirms a match of a SUPI received from a home network and a SUPI used by the UE 320 (although an integrity check failure of the NAS SMC Complete message at the AMF310 may have other causes).

In some examples, the AMF 310 and/or UE 320, when deriving keys for NAS integrity, NAS encryption, and/or NAS authenticated encryption algorithms from the K_{AMF}, may utilize the following parameters to form the string S: FC=0x69, P0=algorithm type distinguisher specific to AEAD, L0=length of algorithm type distinguisher (e.g., 0x00 0x01), P1=algorithm identity specific to AEAD, L1=length of algorithm identity (e.g., 0x00 0x01), P2=AEAD mode distinguisher (E2M/M2E/EncOnly/IntOnly, and L2=length of AEAD mode distinguisher (i.e. 0x00 0x01).

The algorithm type distinguisher may be N-NAS-enc-alg for NAS encryption algorithms and N-NAS-int-alg for NAS integrity protection algorithms. For NAS authenticated encryption algorithms, the algorithm type distinguisher may be N-NAS-authenc-alg or N-NAS-encint-alg. The algorithm type distinguisher may be N-RRC-enc-alg for RRC encryption algorithms, N-RRC-int-alg for RRC integrity protection algorithms, and, for RRC authenticated encryption algorithms, N-RRC-authenc-alg or N-RRC-encint-alg. Further, the algorithm type distinguisher may be N-UP-enc-alg for UP encryption algorithms, N-UP-int-alg for UP integrity protection algorithms, and N-UP-authenc-alg or N-UP-encint-alg for UP authenticated encryption algorithms (see table 1). The values 0x00 and 0x07 to 0xf0 may be reserved for future use, and the values 0xf1 to 0xff may be reserved for private use.

TABLE 1
Algorithm type distinguishers

| Algorithm distinguisher | Value |
|---|---|
| N-NAS-enc-alg | 0x01 |
| N-NAS-int-alg | 0x02 |
| N-RRC-enc-alg | 0x03 |
| N-RRC-int-alg | 0x04 |
| N-UP-enc-alg | 0x05 |
| N-UP-int-alg | 0x06 |
| N-NAS-authenc-alg (or) | 0x07 |
| N-NAS-encint-alg | |
| N-RRC-authenc-alg (or) | 0x08 |
| N-RRC-encint-alg | |
| N-UP-authenc-alg (or) | 0x09 |
| N-UP-encint-alg | |

Table 2 lists different possible AEAD mode distinguishers or indications to indicate different AEAD mode usage for NAS signaling security, RRC security, or UP security, respectively.

TABLE 2
AEAD Mode distinguishers

| Algorithm distinguisher | Value |
|---|---|
| N-NAS-AEAD-E2M-mode | 0x01 |
| N-NAS-AEAD-M2E-mode | 0x02 |
| N-NAS-AEAD-EncOnly-mode | 0x03 |
| N-NAS-AEAD-IntOnly-mode | 0x04 |
| N-RRC-AEAD-E2M-mode | 0x05 |
| N-RRC-AEAD-M2E-mode | 0x06 |
| N-RRC-AEAD-EncOnly-mode | 0x07 |
| N-RRC-AEAD-IntOnly-mode | 0x08 |
| N-UP-AEAD-E2M-mode | 0x09 |
| N-UP-AEAD-M2E-mode | 0x10 |
| N-UP-AEAD-EncOnly-mode | 0x11 |
| N-UP-AEAD-IntOnly-mode | 0x12 |

An algorithm identity, in some cases, may be placed into the four least significant bits of the octet, where the two least significant bits of the four most significant bits are reserved for future use, and the two most significant bits of the most significant nibble are reserved for private use. The entire four most significant bits are set to all zeros.

In some cases, the UE 320 and AMF 310 may derive the AEAD NAS security key using the 256-bit K_{AMF} as an input key. For an algorithm key of length n bits, where n is less or equal to 256 bits or 512 bits or higher, the n least significant bits of the 256 bits of the KDF output can be used as the algorithm key.

In some examples, a nonce, which is used by AEAD algorithms to ensure uniqueness and integrity, may be constructed of multiple parameters, such as a UE ID known to UE 320 and the AMF 310 (e.g., an authenticated unique secret permanent identifier or privacy protected temporary identifier of the UE/subscriber, such as any of IMSI/NAI/SUPI/verified GUTI, Timestamp, or other parameters used in other cipher/integrity algorithms).

In some examples, the AEAD algorithms can include associated data (AD), such as the multiple parameters associated with the nonce construction (e.g., an authenticated unique secret permanent identifier or privacy protected temporary identifier of the UE/subscriber, such as any of IMSI/NAI/SUPI/verified GUTI, Timestamp, or other parameters used in other cipher/integrity algorithms).

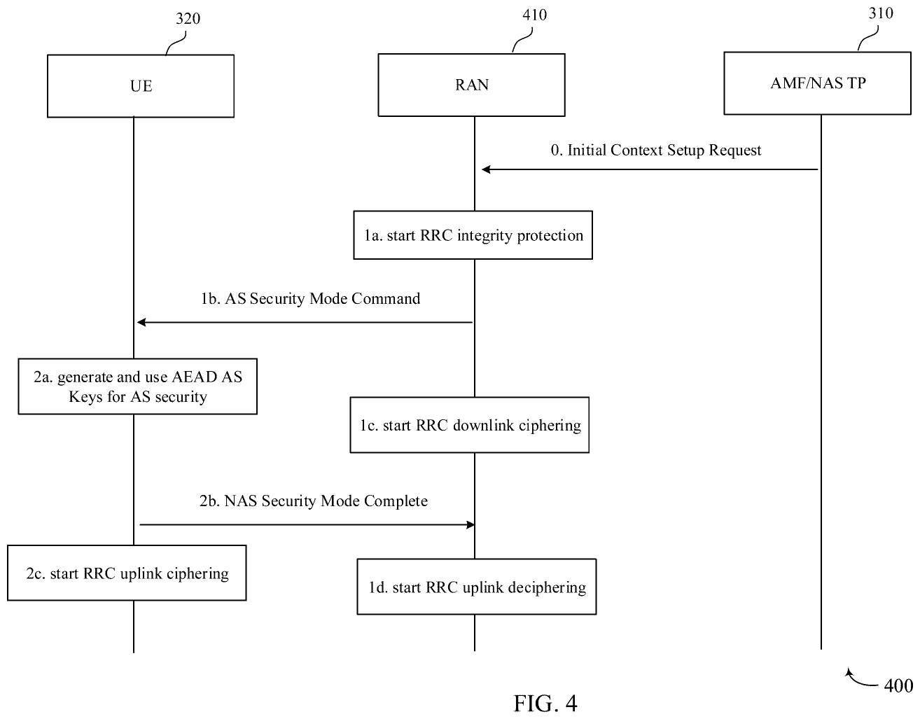

In some examples, a RAN node (e.g., a gNB) may enable selection and use of AEAD modes during AS SMC for AS security (e.g., security for AS signaling) and/or protection (e.g., ciphering and/or integrity protection of RRC and UP). The RAN node may generate AEAD AS security keys (K_{RRCaead} and K_{UPaead}) keys based on AEAD capabilities of the UE (e.g., the UE 220). FIG. 4 illustrates an example messaging flow 400 during an AS SMC procedure in accordance with aspects of the present disclosure.

The messaging flow 400 may implement various aspects of the present disclosure described herein. For example, the messaging flow 400 may include the AMF 310 (or NAS termination point (TP) function), the UE 320, and a RAN node 410, which may be examples of AMFs, UEs, and RAN nodes, as described herein. In the following description of the messaging flow 400, the operations between the AMF 310, the UE 320, and the RAN node 410 may be performed in different orders or at different times. Some operations may also be omitted, or other operations may be added. Although the AMF 310, UE 320, and RAN node 410 are shown performing the operations of the messaging flow 400, some aspects of some operations may also be performed by other entities of the messaging flow 400 or by entities that are not shown in the messaging flow 400, or any combination thereof.

The RAN node 410 (e.g., a gNB) determines and applies an AS SMC using the messaging flow 400 between the gNB and the UE 320. For example, when the UE 320 is in an RRC_Connected state, the AMF 310, the RAN node 410, and the UE 320 may be in agreement over use of AEAD algorithms, including (a) 128-bit or 256-bit ciphering and/or integrity protection of RRC signaling and UP signaling (e.g., between the UE 320 and the gNB), and/or (b) 128-bit or 256-bit ciphering and/or integrity protection of RRC signaling and UP signaling.

The messaging flow 400, in some examples, supports AS SMC procedures for RRC and UP security algorithm negotiation and RRC security activation for the RAN node 410 (e.g., gNB/ng-eNB) and the UE 320. An AS SMC procedure may be triggered to establish a secure RRC signaling-only connection during a UE registration or protocol data unit (PDU) session establishment (e.g., as specified in TS 38.413 and TS 23.502). The activation of UP security may be described based on clause 6.6.2 TS 33.501 and other messaging flows described herein. For example, the AS SMC procedure may include messaging between the RAN node 410 and the UE 320, where the RAN node 410 sends an AS security mode command to the UE 320 and the UE 320 replies with an AS security mode complete message.

At step 0, the AMF 310 transmits an initial context setup request message to the RAN node 410. For example, when the AMF 310 receives the security capabilities of the UE 320 and determines to select and apply AEAD algorithms following a successful reception of a NAS security mode complete message, the AMF 310 initiates an NG application protocol (NGAP) procedure, where the AMF 310 sends the initial context setup request message to the RAN node 410. The initial context setup request message may include the UE security capabilities, such as capabilities to support combined authenticated encryption algorithms (e.g., code related to Snow-3G, AES and ZUC based AEAD), different AEAD modes, per algorithm, (e.g., NCA7, NCA8, NCA9), an “enable or activate AEAD mode indication,” and a security key (K_{gNB}). In some cases, the initial context setup request message may include the AEAD AS key indication.

At step 1a, the RAN node 410 starts RRC integrity protection. For example, a gNB may determine to select and apply the combined authenticated encryption algorithm protection upon receiving the security capabilities from the UE 320 and/or upon an operator policy including AEAD algorithms in a prioritized list. The gNB may perform the AEAD RRC security (e.g., integrity and encryption) key derivation (K_{RRCaead}) and AEAD UP security (e.g., integrity and encryption) key derivation (K_{UPaead}) as described herein. The gNB may activate the RRC integrity protection before sending an AS Security Mode Command message by using the selected AEAD algorithm in the AEAD mode (e.g., int only) and uses the AEAD RRC key for the RRC signaling protection.

At step 1b, the RAN node 410 transmits an AS Security Mode Command message to the UE 320. For example, the AS Security Mode Command message includes the selected AEAD algorithms and enable/selected AEAD mode. The message may be integrity protected with an AEAD RRC integrity key based on a current K_{gNB} and by using the selected AEAD algorithm for integrity protection (e.g., in an AEAD mode of int-only).

At step 2a, the UE 320 generates and uses AEAD AS keys for AS security. For example, the UE 320 may determine to derive an AEAD RRC key based on the received selected RRC algorithm indicating combined authenticated encryption and/or based on the received enable/selected AEAD mode. The UE 320 may determine to derive and use AEAD AS keys (an. AEAD RRC key: K_{RRCaead} and an AEAD UP Key: K_{UPaead}) based on a received ‘Combined authenticated encryption algorithm information/indication’ from the RAN node 410. The UE 320 may verify the AS Security Mode Command message, such as by verifying the integrity protection using the indicated combined authenticated encryption algorithm with AEAD mode (e.g., int-only) and the AEAD RRC key.

At step 2b, the UE 320 transmits an AS security mode complete message to the RAN node 410. The AS security mode complete message may be ciphered and/or integrity protected in an order based on the selected AEAD algorithm and AEAD mode indicated in the AS security mode command message and by using the AEAD RRC key based on the current K_{gNB}.

At step 1c, the RAN node 410 starts RRC downlink ciphering. For example, after sending the AS Security Mode Command message, at step 1b, the RAN node 410 starts the downlink ciphering after receiving and verifying of the AS security mode complete message. When the RAN node 410 determines to apply a combined authenticated encryption algorithm for AS protection, the RAN node 410 (e.g., the gNB), at step 1d, applies RRC uplink deciphering using the AEAD RRC key in AEAD mode (e.g., via E2M, M2E, or Enc-only mode as selected and indicated at step 1b) after sending the NAS Security Mode Command message to the UE 320.

At step 2c, the UE 320 starts RRC uplink ciphering. For example, the UE 320 begins RRC uplink ciphering (encryption) after sending the AS Security Mode Complete message (e.g., with the AEAD RRC security key). In some cases, the UE 320 starts RRC downlink deciphering (decryption) after receiving and verifying the AS Security Mode Command message. When any control of the AS Security Mode Command message is not successful in the UE 320, the UE 320 may reply with an unprotected security mode failure message (see TS 38.331). Further, the ciphering and/or integrity protection of UP downlink and uplink with (e.g., using AEAD UP security key and selected combined authenticated encryption algorithm with selected AEAD mode), at the UE 320 and/or RAN node 410, may begin as defined by clause 6.6.2 TS 33.501.

In some cases, the messaging flow 400 may facilitate the AS SMC during an initial context setup between the UE 320 and the RAN node 410, such as to activate an initial K_{gNB} at or during an RRC_IDLE to RRC_CONNECTED state transition for the UE 320. Derivation of a K_{gNB} during the RRC_IDLE to the RRC_CONNECTED state may ensue that the AS SMC establishes a fresh K_{gNB} (e.g., PDCP COUNTs can be reset).

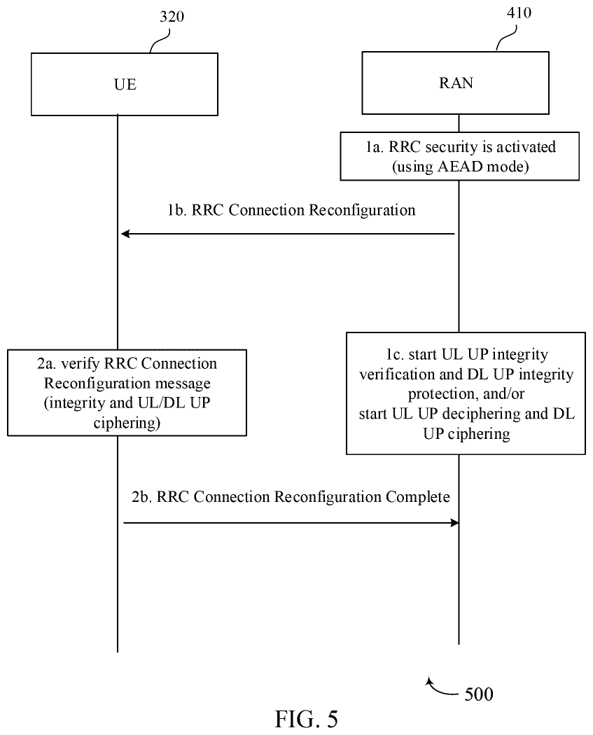

In some examples, the RAN node 410 may enable selection and use of an AEAD mode during RRC re-configuration for UP security activation (per data radio bearer (DRB)). For example, the RAN node 410 may determine and activate an AEAD mode based UP security (e.g., for ciphering and/or integrity protection of a DRB as part of UP security). In some cases, the AS UP integrity protection and ciphering activation is performed as part of a DRB addition procedure, using an RRC Connection Reconfiguration procedure. For example, a Session Management Function (SMF) may transmit an UP security policy to the RAN node 410 (e.g., as defined in Clause 6.6.1 of TS 33.501). FIG. 5 illustrates an example messaging flow 500 during an RRC Reconfiguration procedure in accordance with aspects of the present disclosure.

The messaging flow 500 may implement various aspects of the present disclosure described herein. For example, the messaging flow 500 may include the UE 320, and the RAN node 410, which may be examples of UEs and RAN nodes, as described herein. In the following description of the messaging flow 500, the operations between the UE 320 and the RAN node 410 may be performed in different orders or at different times. Some operations may also be omitted, or other operations may be added. Although the UE 320 and RAN node 410 are shown performing the operations of the messaging flow 500, some aspects of some operations may also be performed by other entities of the messaging flow 500 or by entities that are not shown in the messaging flow 500, or any combination thereof.

At step 1a, the RAN node 410 activates RRC security. For example, the RAN node 410 performs an AS security mode command procedure (e.g., via messaging flow 400) to activate the RRC security.

At step 1b, the RAN node 410 sends an RRC Connection Reconfiguration message to the UE 320. For example, the RAN node 410 sends the message for UP security activation, where the message includes indications of a specific AEAD mode for the activation of UP integrity protection and/or ciphering for each DRB, according to a security policy. For each DRB, UP integrity, UP encryption, UP integrity protection and encryption, or UP encryption and integrity protection, using any of the AEAD modes, is provided.

At step 1c, the RAN node 410 starts UL UP integrity verification and DL UP integrity protection, and/or starts UL UP deciphering and DL UP ciphering. For example, the RAN node 410, when UP integrity protection is activated for DRBs and the RAN node 410 does not have AEAD UP Key, the RAN node 410 generates an AEAD UP Key (as described herein) and stats UP integrity protection for the DRBs. Similarly, when UP ciphering is activated for the DRBs and the RAN node 410 does not have the AEAD UP Key, the RAN node 410 generates an AEAD UP Key and starts UP ciphering for the DRBs.

At step 2a, the UE 320 verifies the RRC Connection Reconfiguration message. When UP integrity protection is activated for the DRBs as indicated in the RRC Connection Reconfiguration message and the UE 320 does not have an AEAD UP Key, the UE 320 generates an AEAD UP Key (as described herein) and starts the UP integrity protection for the DRBs. Similarly, when UP ciphering is activated for the DRBs as indicated in the RRC Connection Reconfiguration message and the UE 320 does not have the AEAD UP Key, the UE 320 generates the AEAD UP Key and starts UP ciphering for the DRBs.

At step 2b, the UE 320 sends an RRC Connection Reconfiguration Complete message to the RAN node 410. For example, the UE 320 sends the message after successfully verifying the integrity of the RRC Connection Reconfiguration message. In some cases, such as when UP integrity protection is not activated for the DRBs, the RAN node 410 and the UE 320 may not integrity protect traffic of a DRB and not put MAC-I into a PDCP packet. Also, when UP ciphering is not activated for the DRBs, the RAN node 410 and the UE 320 may not cipher the traffic of the DRBs.

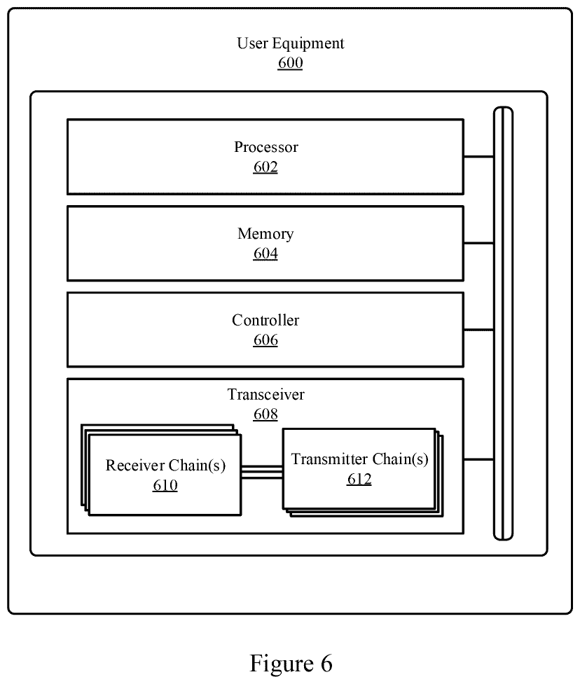

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving, from a network entity, a security mode command message that contains security mode information, including a security context parameter that indicates a security context for communications between the UE and the network entity, one or more AEAD algorithms associated with the security context, and one or more AEAD modes associated with the one or more AEAD algorithms, generating an AEAD security key based on the one or more AEAD algorithms and the one or more AEAD modes, and transmitting, to the network entity, a security mode complete message that is ciphered and integrity protected with the AEAD security key.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

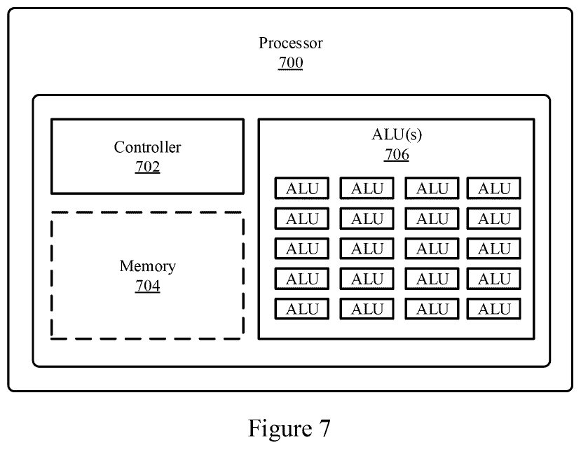

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support a means for receiving, from a network entity, a security mode command message that contains security mode information, including a security context parameter that indicates a security context for communications between the UE and the network entity, one or more AEAD algorithms associated with the security context, and one or more AEAD modes associated with the one or more AEAD algorithms, generating an AEAD security key based on the one or more AEAD algorithms and the one or more AEAD modes, and transmitting, to the network entity, a security mode complete message that is ciphered and integrity protected with the AEAD security key.

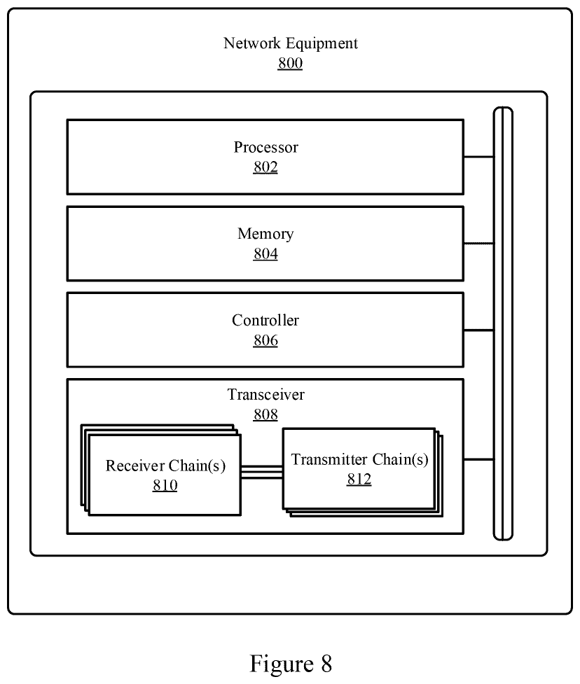

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for receiving, from a UE, a message that contains security capabilities supported by the UE, including one or more AEAD algorithms associated with a security context for communications between the UE and the network entity and one or more AEAD modes associated with the one or more AEAD algorithms, generating an AEAD security key using an AEAD algorithm and an AEAD mode that are supported by the UE, and transmitting, to the UE, a security mode command message that contains security mode information indicating the AEAD algorithm and the AEAD mode used to generate the AEAD key.

As another example, the NE 800 may be configured to support a means for transmitting, to a UE, an RRC connection reconfiguration message that contains an indication of an AEAD mode for activation of UP integrity protection or ciphering for DRB additions during an RRC reconfiguration procedure, initiating, for each DRB, uplink UP integrity verification and downlink UP integrity protection using the AEAD mode, and initiating, for each DRB, uplink UP deciphering and downlink UP ciphering using the AEAD mode.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

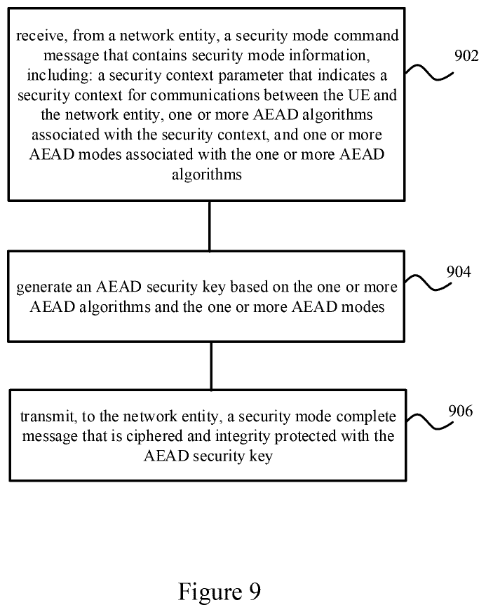

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving, from a network entity, a security mode command message that contains security mode information, including a security context parameter that indicates a security context for communications between the UE and the network entity, one or more AEAD algorithms associated with the security context, and one or more AEAD modes associated with the one or more AEAD algorithms. The operations of 902 may be performed in accordance with examples as described herein. In some implementations, aspects of the operations of 902 may be performed by a UE as described with reference to FIG. 6.

At 904, the method may include generating an AEAD security key based on the one or more AEAD algorithms and the one or more AEAD modes. The operations of 904 may be performed in accordance with examples as described herein. In some implementations, aspects of the operations of 904 may be performed a UE as described with reference to FIG. 6.

At 906, the method may include transmitting, to the network entity, a security mode complete message that is ciphered and integrity protected with the AEAD security key. The operations of 906 may be performed in accordance with examples as described herein. In some implementations, aspects of the operations of 906 may be performed a UE as described with reference to FIG. 6.

It should be noted that the method described herein describes a possible implementation, and that the operations and the steps may be rearranged or otherwise modified and that other implementations are possible.

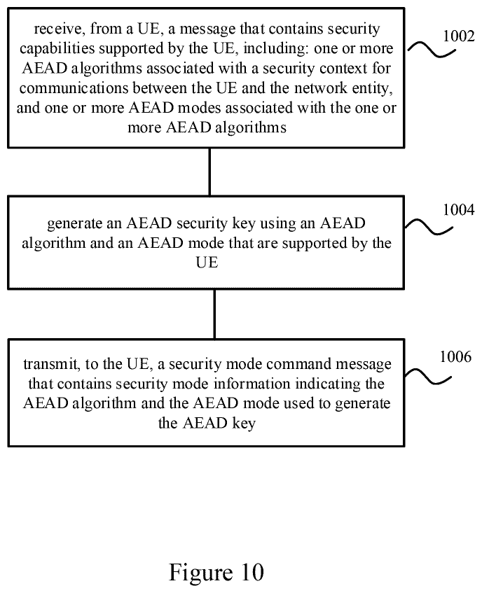

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include receiving, from a UE, a message that contains security capabilities supported by the UE, including one or more AEAD algorithms associated with a security context for communications between the UE and the network entity and one or more AEAD modes associated with the one or more AEAD algorithms. The operations of 1002 may be performed in accordance with examples as described herein. In some implementations, aspects of the operations of 1002 may be performed by a NE as described with reference to FIG. 8.

At 1004, the method may include generating an AEAD security key using an AEAD algorithm and an AEAD mode that are supported by the UE. The operations of 1004 may be performed in accordance with examples as described herein. In some implementations, aspects of the operations of 1004 may be performed by a NE as described with reference to FIG. 8.

At 1006, the method may include transmitting, to the UE, a security mode command message that contains security mode information indicating the AEAD algorithm and the AEAD mode used to generate the AEAD key. The operations of 1006 may be performed in accordance with examples as described herein. In some implementations, aspects of the operations of 1006 may be performed by a NE as described with reference to FIG. 8.

It should be noted that the method described herein describes a possible implementation, and that the operations and the steps may be rearranged or otherwise modified and that other implementations are possible.

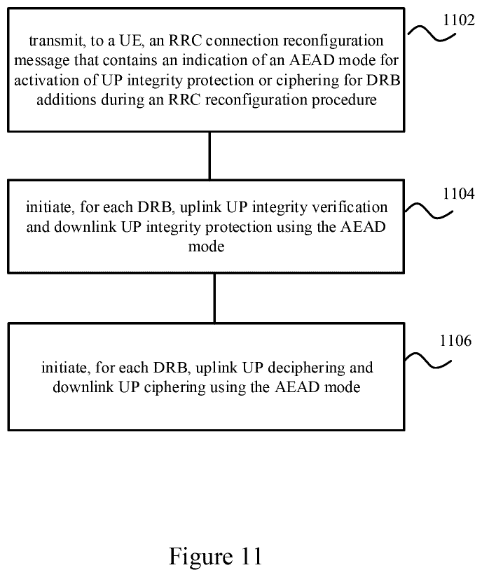

FIG. 11 illustrates a flowchart of a method in accordance with aspects of the present disclosure. The operations of the method may be implemented by a NE as described herein. In some implementations, the NE may execute a set of instructions to control the function elements of the NE to perform the described functions.

At 1102, the method may include transmitting, to a UE, an RRC connection reconfiguration message that contains an indication of an AEAD mode for activation of UP integrity protection or ciphering for DRB additions during an RRC reconfiguration procedure. The operations of 1102 may be performed in accordance with examples as described herein. In some implementations, aspects of the operations of 1102 may be performed by a NE as described with reference to FIG. 8.

At 1104, the method may include initiating, for each DRB, uplink UP integrity verification and downlink UP integrity protection using the AEAD mode. The operations of 1104 may be performed in accordance with examples as described herein. In some implementations, aspects of the operations of 1104 may be performed by a NE as described with reference to FIG. 8.

At 1106, the method may include initiating, for each DRB, uplink UP deciphering and downlink UP ciphering using the AEAD mode. The operations of 1106 may be performed in accordance with examples as described herein. In some implementations, aspects of the operations of 1106 may be performed by a NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, a security mode command message that contains security mode information, including:
a security context parameter that indicates a security context for communications between the UE and the network entity;
one or more authenticated encryption with associated data (AEAD) algorithms associated with the security context; and
one or more AEAD modes associated with the one or more AEAD algorithms;
generate an AEAD security key based on the one or more AEAD algorithms and the one or more AEAD modes; and
transmit, to the network entity, a security mode complete message that is ciphered and integrity protected with the AEAD security key.

2. The UE of claim 1, wherein the security context parameter indicates a non-access stratum (NAS) security context for the communications between the UE and the network entity.

3. The UE of claim 1, wherein the security context parameter indicates an access stratum (AS) security context for the communications between the UE and the network entity.

4. The UE of claim 3, wherein the AS security context includes a radio resource control (RRC) security context.

5. The UE of claim 3, wherein the AS security context includes a user plane (UP) security context.

6. The UE of claim 1, wherein the security mode command message contains a prioritized list of AEAD algorithms selected by the network entity, and wherein the at least one processor is configured to cause the UE to generate the AEAD security key using an AEAD algorithm that is supported by the UE and that has a high priority in the prioritized list.

7. The UE of claim 1, wherein the one or more AEAD algorithms include a SNOW-3G based algorithm, an advanced encryption standard (AES) based algorithm, or a ZUC based algorithm.

8. The UE of claim 1, wherein the one or more AEAD modes include:
an encrypt-then-MAC (EtM) mode;
a MAC-then-encrypt (MtE) mode;
an encryption only mode; or
an integrity only mode.

9. A network entity for wireless communication, comprising:
at least one memory; and
at least one processor coupled with the at least one memory and configured to cause the network entity to:
receive, from a user equipment (UE), a message that contains security capabilities supported by the UE, including:
one or more authenticated encryption with associated data (AEAD) algorithms associated with a security context for communications between the UE and the network entity; and
one or more AEAD modes associated with the one or more AEAD algorithms;
generate an AEAD security key using an AEAD algorithm and an AEAD mode that are supported by the UE; and
transmit, to the UE, a security mode command message that contains security mode information indicating the AEAD algorithm and the AEAD mode used to generate the AEAD key.

10. The network entity of claim 9, wherein the at least one processor is further configured to cause the network entity to:
receive, from the UE, a security mode complete message that indicates an AEAD algorithm and an AEAD mode used by the UE;
de-cipher and check integrity protection applied to the security mode complete message using the generated AEAD key and the indicated AEAD algorithm and AEAD mode; and
activate downlink ciphering with the UE using the security context.

11. The network entity of claim 9, wherein the security context is a non-access stratum (NAS) security context for the communications between the UE and the network entity.

12. The network entity of claim 9, wherein the security context is an access stratum (AS) security context for the communications between the UE and the network entity.

13. The network entity of claim 12, wherein the AS security context includes a radio resource control (RRC) security context.

14. The network entity of claim 12, wherein the AS security context includes a user plane (UP) security context.

15. The network entity of claim 9, wherein the network entity is: an access and mobility function (AMF), a non-access stratum (NAS) termination point function, or a control plane termination point.

16. The network entity of claim 9, wherein the network entity is a radio access network (RAN) node.

17. The network entity of claim 9, wherein the one or more AEAD algorithms include a SNOW-3G based algorithm, an advanced encryption standard (AES) based algorithm, or a ZUC based algorithm.

18. The network entity of claim 9, wherein the one or more AEAD modes include:
an encrypt-then-MAC (EtM) mode;
a MAC-then-encrypt (MtE) mode;
an encryption only mode; or
an integrity only mode.

19. A radio access network (RAN) node for wireless communication, comprising:
at least one memory; and
at least one processor coupled with the at least one memory and configured to cause the RAN node to:
transmit, to a user equipment (UE), a radio resource control (RRC) connection reconfiguration message that contains an indication of an authenticated encryption with associated data (AEAD) mode for activation of user plane (UP) integrity protection or ciphering for data radio bearer (DRB) additions during an RRC reconfiguration procedure;
initiate, for each DRB, uplink UP integrity verification and downlink UP integrity protection using the AEAD mode; and
initiate, for each DRB, uplink UP deciphering and downlink UP ciphering using the AEAD mode.

20. A method performed by a user equipment (UE), the method comprising:
receiving, from a network entity, a security mode command message that contains security mode information, including:
a security context parameter that indicates a security context for communications between the UE and the network entity;
one or more authenticated encryption with associated data (AEAD) algorithms associated with the security context; and
one or more AEAD modes associated with the one or more AEAD algorithms;
generating an AEAD security key based on the one or more AEAD algorithms and the one or more AEAD modes; and
transmitting, to the network entity, a security mode complete message that is ciphered and integrity protected with the AEAD security key.
